(19) United States
(12) Patent Application Publication
(10) Pub. No.: US 2005/0155978 A1
(43) Pub. Date: Jul. 21, 2005

(54) System for batching product portions

(75) Inventors: Eugene Parets, Buford, GA (US); Robert Dirksen, Suwanee, GA (US)

Correspondence Address: WATTS HOFFMANN CO., L.P.A., Ste. 1750, 1100 Superior Avenue, Cleveland, OH, 44114, US

(73) Assignee: GAINCO, INC.

(21) Appl. No.: 10/758,337

(22) Filed: Jan. 15, 2004

(51) Int. Cl. B67B 7/00; G01F 11/00

(52) U.S. Cl. 222/1

(57) ABSTRACT

A system for separating a supply of product portions into batches. The system accumulates a first plurality of said product portions from a first flow path and are weighed in a first weigher. The product portions are directed from the supply along a second flow path when a weight of the of product portions in the first weigher reaches a first predetermined weight. Product portions are accumulated from the second flow path and are weighed in a second weigher. A first batch of product portions is discharged from the first weigher when the weight of the first plurality of product portions is within a first predetermined weight range. A second batch of product portions is discharged from the second weigher when the weight of the second plurality of product portions is within a second predetermined weight range.

### FIELD OF THE INVENTION

The present invention relates generally to a system for separating a supply of product portions into batches of product portions and, in particular, the present invention relates a system that directs the product portions to multiple weighers to increase the number of accurately weighed batches produced.

### BACKGROUND OF THE INVENTION

Processors of product portions, such as poultry, beef, pork and fish portions or other such products often must accurately separate a continuous stream or supply of product portions into batches having the same or nearly the same weight. These batches are then moved to a downstream process. The moving supply of product portions is often delivered by conveyor from an upstream operation, such as a cut-up, deboning or freezing operation with a substantially fixed output rate. Processors separate the supply of product portions into batches for packaging into bags, trays, boxes or other containers. Processors try to achieve precise batch weights to assure proper package weights.

In the past, batching product portions, particularly meat portions, has been very slow and labor intensive. In general, meat portions are delivered to a batching workstation by an infeed conveyor. In some applications, operators simply load the portions into a package situated on a weight scale. The package is loaded until it reaches the desired weight. Then the package is removed and the process is repeated. In other applications, operators at workstations load weighing hoppers to a desired weight and then the weighing hoppers dump the batches directly into to a container or into a pocketed conveyor belt for delivery to another operation.

Several inefficiencies are prevalent when operators manually load the packages or weighing hoppers. For example, the flow of product portions from an infeed conveyor is continuous and any operator bottlenecks cause the portions to overflow the workstation. In addition, operators may not load the package to the proper weight. Most commonly, when rushed, an operator tends to load an excessive weight of portions into a package or hopper. This results in losses to the food processor.

Batching product portions is more challenging when the weight of the batch is not a multiple of the weight of a typical portion of the product. For example, a 5 pound bag of chicken breast meat may include breasts that average 0.75 pounds. If the bag is filled with 6 whole breasts, the bag will only have 4.5 pounds of meat and will be underweight. If the bag is filled with 7 whole breasts, the bag will weigh 5.25 pounds and processor will be “giving away” 0.25 pounds of meat with each package. Chicken breast meat, like other products, is expensive and processors strongly want to eliminate giving away this meat. As a result operators may introduce smaller, hand cut portions of breast meat into the bag in order to bring the weight of the batch within an acceptable range.

The present invention eliminates most of the manual hand loading of product portions into a weigher by automatically diverting the stream of product portions in an alternating fashion to multiple weighers. The present invention increases the output of an operator, since the operator only has to add or subtract portions or pieces of portions to “make weight” and does not have to load each weigher.

### SUMMARY OF THE INVENTION

The present invention concerns a method for sorting product portions into batches. In the method, product portions are directed from a supply along a first flow path. A first plurality of product portions is accumulated at a first weighing station on the first flow path. The first plurality of product portions is weighed. The product portions are directed from the supply along a second flow path once the weight of the first plurality of product portions has reached a first predetermined weight. A first batch of product portions is discharged when the first plurality of product portions is within a predetermined weight range. A second plurality of product portions is accumulated at a second weighing station on the second flow path. The second plurality of product portions is weighed. The product portions are directed from the supply back along the first flow path after a weight of the second plurality of product portions reaches a second predetermined weight. A second batch of product portions is discharged when the second plurality of product portions is within a predetermined weight range. The product portions may be directed along additional flow paths before the product portions are directed back along the first flow path.

In one embodiment, product is added or removed from an accumulated plurality of product portions to bring the weight of the accumulated plurality of product portions within the predetermined weight range. The product may be manually added or removed to bring the plurality of product portions into the predetermined weight range.

One system for performing the method of sorting product portions into batches includes a directing structure, a first weigher, a second weigher, and a batch weight controller. The directing structure has an entrance that accepts the product portions from the supply. The first weigher accepts the product portions from the directing structure. The first weigher accumulates the product portions and produces a first weight signal having a value that relates to a weight of product portions accumulated in the first weigher. A second weigher accepts the product portions from the directing structure. The second weigher accumulates the product portions and produces a second weight signal having a value that relates to a weight of product portions accumulated in the second weigher. A batch weight controller receives the first and second weight signals from the first and second weighers and sends signals for operating the directing structure, the first weigher, and the second weigher. The controller sends a first signal to operate the directing structure to direct the product portions along a first flow path to the first weigher until the value of the first weight signal indicates that the accumulated weight of product portions in the first weigher has reached a first predetermined weight. When the product portions in the first weigher reach the first predetermined weight, the controller sends a second signal to operate the directing structure to direct the product portions from the supply along a second flow path to the second weigher until the value of the second weight signal indicates that the accumulated weight of product portions in the second weigher has reached a second predetermined weight.

In one embodiment, the controller sends a third signal to open the exit of the first weigher when the weight of product portions in the first weigher is within a first predetermined weight range. The controller may send a fourth signal to open the exit of the second weigher when the weight of product portions in the second weigher is within a second predetermined weight range. The first and second predetermined weights and first and second predetermined weight ranges may be different to produce batches having different weights. The first and second predetermined weights and first and second predetermined weight ranges may be the same to produce batches having approximately the same weight.

In one embodiment, the system includes a first staging hopper positioned along the flow path to receive batches of product portions from the first weigher. The controller provides a signal to the first staging hopper that controls a time of release of batches of product portions from the staging hopper. A second staging hopper may be positioned to receive batches of product portions from the second weigher. The controller provides a signal to the second staging hopper that controls a time of release of batches of product portions from the staging hopper.

In one embodiment, the system includes a funnel that directs batches of the product portions from the first weigher and the second weigher to a predetermined location. When staging hoppers are included, the funnel receives the batches of product portions from the weighers via the staging hoppers.

Additional features of the invention will become apparent and a fuller understanding will be obtained by reading the following detailed description in connection with the accompanying drawings.

### BRIEF DESCRIPTION OF THE DRAWINGS

FIG. 1 is an elevational view of a system for separating a supply of product portions into batches;

FIG. 2 is a view seen approximately from the plane indicated by the line 2-2 of FIG. 1 of a system for separating a supply of product portions into batches;

FIG. 3 is an enlarged fragmentary view of a portion of the system shown in FIG. 2;

FIG. 4 is a view seen approximately from the plane indicated by the line 4-4 of FIG. 3;

FIG. 5 is an enlarged fragmentary view of a portion of the system shown in FIG. 2;

FIG. 6 is a view seen approximately from the plane indicated by the line 6-6 of FIG. 5;

FIG. 7 is a view seen approximately from the plane indicated by the line 7-7 of FIG. 6;

FIG. 8 is an enlarged fragmentary view of a portion of the system shown in FIG. 2;

FIG. 9 is a view seen approximately from the plane indicated by the line 9-9 of FIG. 8;

FIG. 10 is a view seen approximately from the plane indicated by the line 10-10 in FIG. 9;

FIG. 11 is schematic representation of operator work stations and weighers.

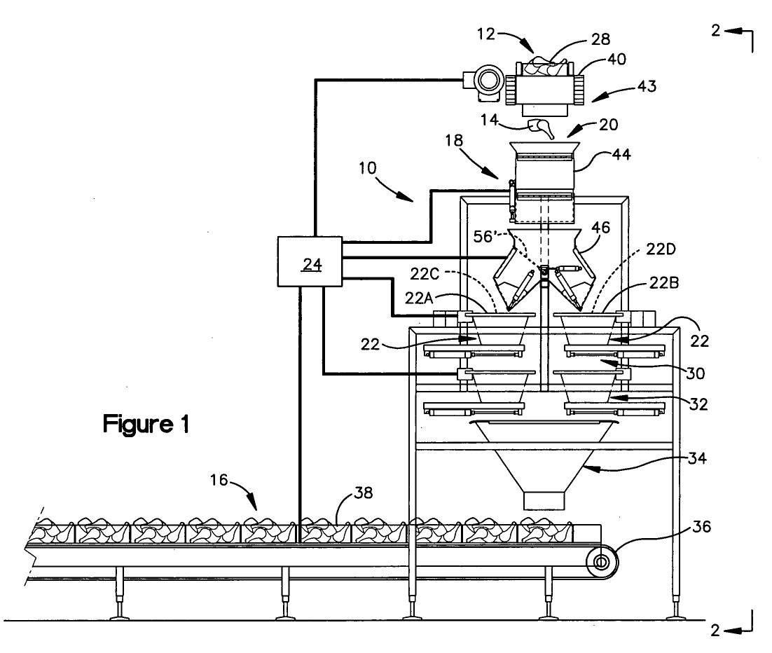

### DETAILED DESCRIPTION OF THE INVENTION

The present disclosure concerns a system 10 for sorting a supply 12 of product portions 14 into batches 16. The system 10 includes a directing structure 18, weighers 22, and a batch weight controller 24. The batch weight controller 24 communicates with the directing structure 18 and the weighers 22. The directing structure directs the product portions 14 from the supply 12 to the weighers 22. Each weigher discharges a batch 16 of product portions when the weight of product portions in the weigher is within an acceptable batch weight range.

The illustrated directing structure has an entrance 20 that accepts the product portions 14 from the supply 12. In the illustrated embodiment, the product portions 14 are chicken portions. The illustrated supply 12 of product portions 14 includes a conveyor 40. The illustrated conveyor 40 moves at a fixed speed and provides an unsteady, non-singulated, or “lumpy” flow of product portions. The illustrated conveyor is a flighted belt that allows the product portions to be moved up hill. The illustrated supply conveyor 40 is part of a separate system having its own controller, electrical power, pneumatics and water supply. The supply conveyor 40 is also coupled to the controller 24 in the exemplary embodiment, allowing the conveyor to be stopped by the controller 24.

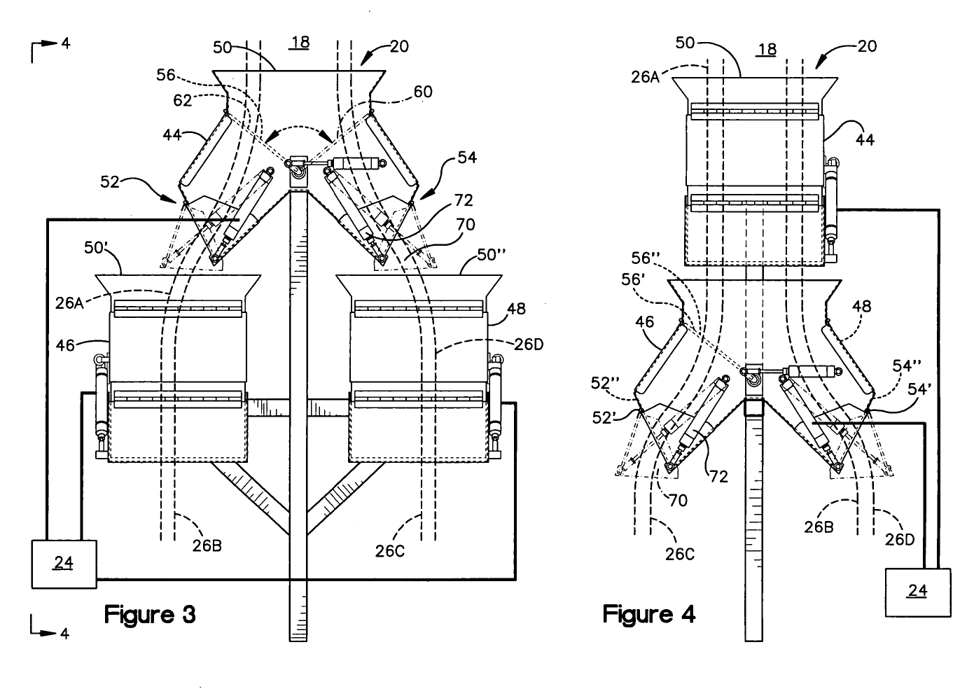

The illustrated directing structure 18 directs product portions along four flow paths 26A, 26B, 26C, 26D (FIGS. 3 and 4) to four weighers 22A, 22B, 22C and 22D. The illustrated directing structure 18 is a gravity based system that includes first, second and third diverters 44, 46, 48. A system that includes two weighers would require only one diverter.

Only the first diverter 44 is described in detail since the first, second and third diverters are substantially the same in the illustrated embodiment. The corresponding structure in the second and third diverters 46, 48 are identified with the reference characters that identify the corresponding structure in the first diverter with the addition of a ′ and ″, respectively. Referring to FIGS. 3 and 4, the first diverter 44 has an entrance 50 that accepts the supply 12 of product portions 14 from the exit 43 of the supply conveyor 40. The entrance 50 is defined by an opening at the top of the diverter. The first diverter 44 includes first and second selectively openable and closable exits 52, 54 positioned above the second and third diverters 46, 48. In the illustrated embodiment, the exits 52, 54 of the diverter 44 include a door 70 that is selectively openable and closable by an actuator 72. The actuator is controlled by the controller 24 to selectively open or close the exits. The diverter 44 includes a directing flap 56 that is selectively movable between a first position 60 and a second position 62 by an actuator 58 (FIG. 3). In the first position, the flap 56 directs product portions from the entrance 50 to the first exit 52. In the second position the flap 56 directs product portions to the second exit 54. In the illustrated embodiment, the entrance 50 is positioned below the conveyor 40 to receive product portions 14 as they fall from the conveyor 40.

The entrance 50′ of the second diverter 46 is positioned to accept product portions 14 from the first exit 52 of the first diverter 44 when the first exit 52 is open, the directing flap is in the first position 60, and product portions are being supplied to the first diverter. The first and second exits 52′, 54′ of the second diverter 46 are positioned above first and second weighers 22A, 22B.

The entrance 50″ of the third diverter 48 is positioned to accept product portions 14 from the second exit 54 of the first diverter 44. When the second exit 54 is open, the directing flap is in the second position 62, and product portions are being supplied to the first diverter. The first and second exits 52″, 54″ of the third diverter 48 are positioned above third and fourth weighers 22C, 22D.

As is illustrated by FIGS. 3 and 4 product portions are selectively directed along the first, second, third and fourth flow paths 26A, 26B, 26C, and 26D by selectively positioning the directing flaps and opening and closing the exits of the diverters 44, 46, 48. Product portions are directed along the first flow path 26A when the directing flap 56 of the first diverter is in the first position, the first exit 52 of the first diverter 44 is open, the directing flap of the second diverter is in the first position, the first exit 52′ of the second diverter is open and the rest of the exits of the diverters are closed. Product portions 14 that travel along the first flow path 26A travel through the entrance 50 to the first diverter 44, are directed through the first exit 52 by the directing flap 56, fall through the entrance 50′ of the second diverter 46, and are directed through the first exit 52′ of the second chute by the directing flap 56′.

Product portions are directed along the second flow path 26B when the diverting flap 56 of the first diverter is in the first position, the first exit 52 of the first diverter 44 is open, the directing flap 56′ of the second diverter is in the second position, the second exit 54′ of the second diverter 46 is open and the rest of the exits of the diverters are closed. Product portions 14 that travel along the second flow path 26B travel through the entrance 50 to the first diverter 44, are directed through the first exit 52 by the directing flap 56, fall through the entrance 50′ of the second diverter 46, and are directed through the second exit 54′ of the second chute by the directing flap 56′.

Product portions are directed along the third flow path 26C when the directing flap 56 of the first diverter is in the second position 62, the second exit 54 of the first diverter 44 is open, the directing flap 56″ of the second diverter is in the first position, the first exit 52″ of the third diverter 46 is open and the rest of the exits of the diverters are closed. Product portions 14 that travel along the third flow path 26C travel through the entrance 50 to the first diverter 44, are directed through the second exit 54 by the directing flap 56, fall through the entrance 50″ of the third diverter 48, and are directed through the first exit 52″ of the third chute by the directing flap 56″.

Product portions are directed along the fourth flow path 26D when the directing flap 56 of the first diverter is in the second position, the second exit 54 of the first diverter 44 is open, the directing flap 56″ of the second diverter is in the second position, the second exit 54″ of the third diverter 48 is open and the rest of the exits of the diverters are closed. Product portions 14 that travel along the fourth flow path 26D travel through the entrance 50 to the first diverter 44, are directed through the second exit 54 by the diverting flap 56, fall through the entrance 50″ of the third chute 48, and are directed through the second exit 54″ of the third chute by the directing flap 56″.

It should be readily apparent to those skilled in the art that a directing structure other than the illustrated directing structure could be used without departing from the spirit and scope of the present invention. For example, a directing structure that comprises a movable chute or flexible hose having one inlet and one outlet could be moved in a controlled manner to direct the product portions along flow paths to a plurality of weighers. As another example, the first diverter 44 could be replaced with any structure that directs the product portions from the supply 12 to the second and third diverters 46, 48 without departing from the scope of the present invention.

Weighers 22 are positioned to accept the product portions 14 from the directing structure 18. The weighers 22 accumulate the product portions and each produce a weight signal having a value that relates to a weight of product portions 14 accumulated in the weigher. In the illustrated embodiment, first, second, third, and fourth weighers 22A, 22B, 22C, 22D receive product portions that move along the first, second, third and fourth flow paths 26A, 26B, 26C, 26D respectively. The first weigher 22A receives product portions that pass through the first exit of the second diverter 46. The second weigher 22B receives product portions that pass through the second exit of the second diverter 46. The third weigher 22C receives product portions that pass through the first exit of the third diverter 48. The fourth weigher 22D receives product portions that pass through the second exit of the third diverter 48.

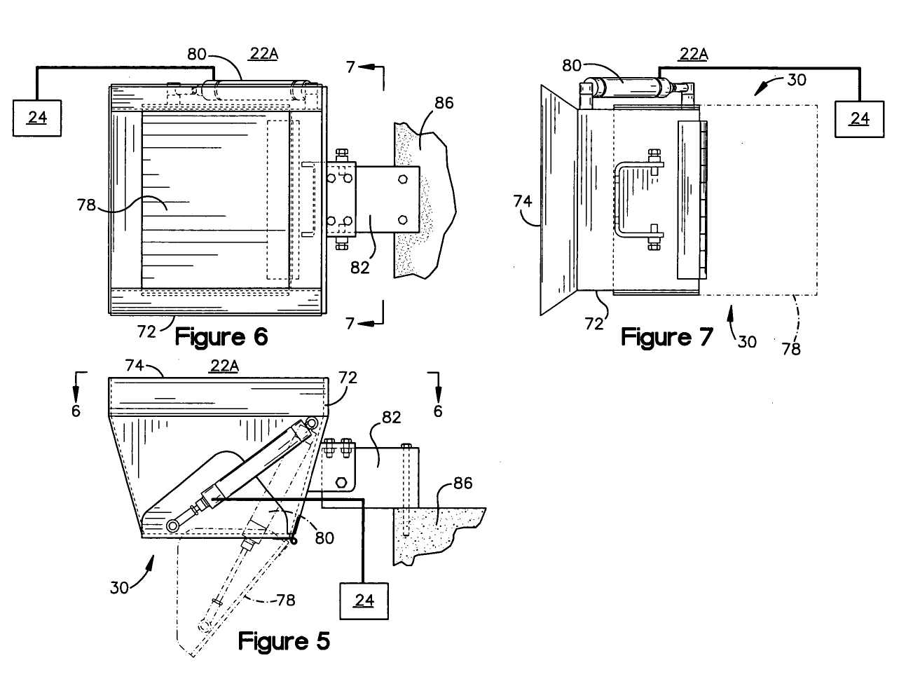

Only the first weigher 22A is described in detail since the weighers 22A, 22B, 22C, 22D are substantially identical. The reference characters used to identify structure of the first weigher also identify the corresponding structure of the other weighers. Referring to FIGS. 5, 6 and 7 the first weighers 22A includes a receptacle 72 with an entrance opening 74 and an exit 30. The exit 30 includes a door 78 that is selectively openable and closable by an actuator 80. The actuator 80 is controller by the controller 24 to selectively open or close the exit of the weighers 22A. In the exemplary embodiment, each weigher 22A includes a load cell 82 that measures the weight of the contents of the weigher 22. The load cell 82 provides a signal to the controller 24 that has a value that is indicative of the weight of the contents of the weigher. Referring to FIG. 5, the load cell 82 is interposed between the weigher 22 and a member of a support framework 86. In the illustrated embodiment, the weigher 22A includes a mounting flange 85. The mounting flange 85 is bolted to the load cell 82. The load cell is bolted to the framework 86.

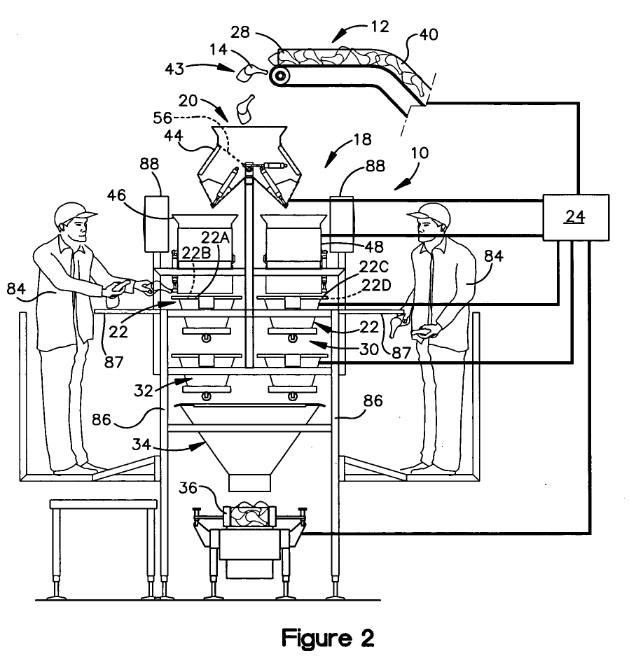

Referring to FIGS. 2 and 11, two human operators 84 stand on opposite sides of a framework 86 that supports the system 10. The operators 84 add or remove product to the weighers 22 to bring the weight of product in a weigher within the acceptable batch weight range. For example, the operator may toss hand cut chicken parts into the weighing hopper to “make weight.” Similarly, the operator may remove a chicken portion from the weigher, cut the portion into two pieces, and place one of the pieces back into the weigher to bring the weight of chicken in the weigher within the acceptable batch weight range. The second piece is saved to be added to a later processed batch. More than one piece may need to be added to or removed from the weigher to “make weight.”

In the exemplary embodiment, work table surfaces 87 are provided around the weighers 22. These worktable surfaces may be adjustable in height to accommodate workers of different heights. The worktable surfaces are provided for the operators to add or remove product portions from a weigher. The weigher may also include a weight readout indicator 88 in one embodiment. In another embodiment, the indicator includes a “below weight” indicator, an “above weight” indicator and a “within acceptable weight range” indicator. The indicator is positioned at a level that is easy to read by the operator. Target weight ranges and units of measure set by the controller are displayed by the indicator 88. Other information that could be displayed includes an indication of the total number of batches released by the weigher and the total weight released by the weigher.

The batch weight controller 24 receives the weight signals from the weighers and sends signals for operating the directing structure 18 and the weighers 22. The controller 24 sends a signal to operate the directing structure 18 to direct the product portions along the first flow path 26A to the first weigher 22A until the value of the weight signal provided by the first weigher indicates that the accumulated weight of product portions in the first weigher has reached a predetermined weight. Once the weight of product portions accumulated in the first weigher 22A reach the first predetermined weight, the controller sends a second signal to operate the directing structure 18 to direct the product portions from the supply along the second flow path 26B to the second weigher 22B until the value of the second weight signal provided by the second weigher indicates that the accumulated weight of product portions in the second weigher has reached a second predetermined weight.

The predetermined weight may be, for example, the lowest acceptable weight of an acceptable weight range. The predetermined weight may be outside the acceptable weight range. For example, the predetermined weight may be slightly lower than the lower value of the acceptable weight range.

After flow of product portions to the weigher 22A is stopped by the controller 24 because the weight of product portions in the weigher has reached the predetermined weight, some product 28 may need to be added or removed from the weigher 22 to bring the weight of product in the weigher into a predetermined acceptable weight range. In the exemplary embodiment, a lower value of the predetermined acceptable weight range corresponds to the minimum acceptable batch weight and the upper value of the range corresponds to the maximum acceptable batch weight. An operator 84 adds or remove product from the first weigher to bring the weight of product in the first weigher within an acceptable batch weight range. In the exemplary embodiment, the controller sends a signal to a weigher 22A to open an exit 30 of a weigher when the weight of product portions 14 in the weigher is within the predetermined weight range.

When the product portions 14 in the first weigher 22A reach the predetermined weight the controller 24 sends a signal to operate the diverters to direct the product portions from the supply 12 to the second weigher 22B. In the exemplary embodiment, the operator 84 adds or removes product from the first weigher 22A while product portions are delivered to the second weigher 22B. Product portions 14 are delivered to the second weigher 22B until the weight of product in the second weigher reaches the predetermined weight for the second weigher. The predetermined weight at which flow of product portions to the first weigher 22A is diverted would be the same as the predetermined weight at which the flow of product portions to the second weigher is diverted if the first and second weighers are producing batches having the same weight and would be different if the first and second weighers are producing batches having different weights. The predetermined batch weights for each weigher can be individually set or adjusted if desired. An operator 84 adds or removes product from the second weigher to bring the weight of product in the second weigher within an acceptable batch weight range. The controller 24 opens the exit 30 of the second weigher 22B when the weight of product in the second weigher is within the acceptable batch weight range for the second weigher.

When the weight of product portions 14 in the second weigher reaches the predetermined weight for the second weigher the controller 24 sends a signal to operate the diverters to direct the product portions from the supply 12 to the third weigher 22C. Product portions 14 are delivered to the third weigher 22C until the weight of product in the third weigher reaches the predetermined weight for the third weigher. An operator 84 adds or removes product from the third weigher to bring the weight of product in the third weigher within the acceptable batch weight range. The controller 24 opens the exit 30 of the third weigher 22C when the weight of product in the third weigher is within the acceptable batch weight range for the third weigher.

When the weight of product portions 14 in the third weigher reaches the predetermined weight for the third weigher the controller 24 sends a signal to operate the diverters to direct the product portions from the supply 12 to the fourth weigher 22D. Product portions 14 are delivered to the fourth weigher 22D until the weight of product in the fourth weigher reaches the predetermined weight for the fourth weigher. An operator 84 adds or removes product from the fourth weigher to bring the weight of product in the fourth weigher within the acceptable batch weight range. The controller 24 opens the exit 76 of the fourth weigher 22D when the weight of product in the fourth weigher is within the acceptable batch weight range for the third weigher.

When the weight of product portions 14 in the fourth weigher reaches the predetermined weight for the fourth weigher the controller 24 sends a signal to operate the diverters to direct the product portions from the supply 12 back to the first weigher 22A. In the exemplary embodiment, the previous batch 16 of product portion is discharged from the first weigher before the product portions are directed back to the first weigher. The weighers are alternately supplied with product portions in this manner to divide the product portions into batches.

In the illustrated embodiment, the system also includes staging hoppers 32, and a funnel 34 or discharge chute that provides batches 16 to an indexing, pocketed conveyor belt 36. The staging hoppers 32 are positioned to receive batches 16 of product portions from a respective weigher 22. The controller 24 provides a signal to the staging hopper that controls a time of release of each batch of product portions from the staging hopper 32 to the funnel 34. In the illustrated embodiment, the funnel aligns a discharged or dumped batch 16 of product portions with the conveyor belt. The controller 24 times the release of each batch 16 from the staging hoppers 32 such that each batch falls into a pocket 38 of the conveyor belt 36. In the illustrated embodiment, four weighers are included. However, it should be apparent that the system could include any number of weighers. One such system includes two weighers.

In the illustrated embodiment, a staging hopper 32 is positioned below each weigher 22 to receive batches of portions. The controller provides a signal to the staging hopper 32 that controls a time of release of the batches 16 of product portions from the staging hopper. In the exemplary embodiment, a common funnel 34 is positioned below the staging hoppers 34 to direct each batch to a common point over the flighted belt 36 used to take the batches to a packaging station (not shown).

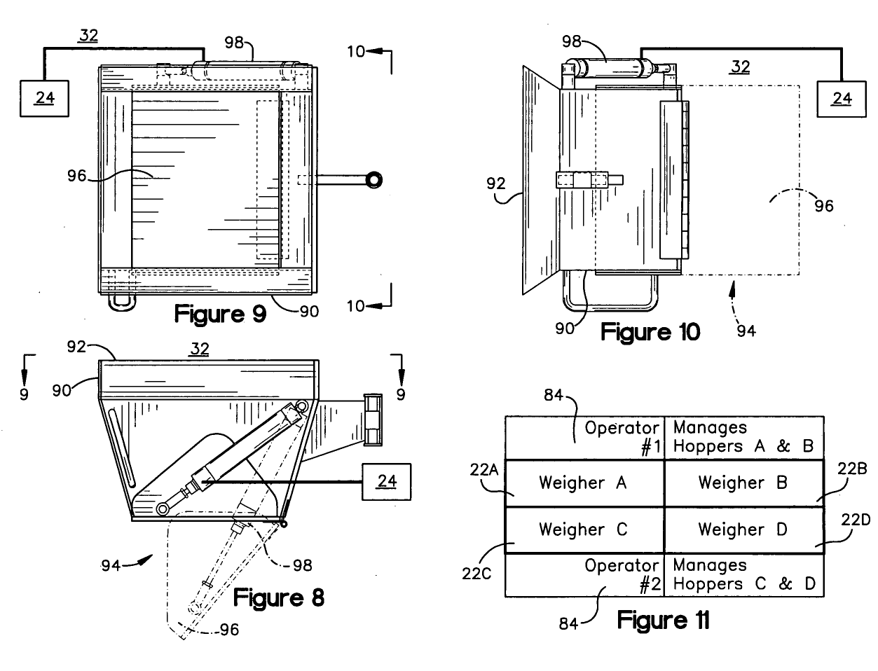

Referring to FIGS. 8-10 each staging hopper includes a receptacle 90 with an entrance opening 92 and an exit 94. The exit 94 includes a door 96 that is selectively openable and closable by an actuator 98. The actuator 98 is controlled by the controller 24 to selectively open and close the exit of the staging hopper 32. The controller opens the exits 94 of the staging hoppers so that each batch 16 falls into a pocket 38 of the conveyor 36. In the exemplary embodiment, the controller ensures that only one batch is deposited in each pocket 38 and that the flow of batches to the belt is smooth and uninterrupted. In the illustrated embodiment, the staging hopper drops the batches 16 onto the belt 36 that moves the batches to a packaging machine, such as a boxing machine or a bagging machine. In one embodiment, the controller 24 communicates with the downstream boxing or bagging machine to be sure that the machine is ready to receive batches of portions before portion infeed and batching begin. In an alternate embodiment, the staging hoppers 32 provide the batches directly to a packaging machine.

In the illustrated embodiment, the conveyor 36 takes the batches 16 away from the system 10 to a packaging station, such as a VFFS packaging machine. The illustrated conveyor is a flighted belt with pockets 38. In one embodiment, the pockets are on 12 inch centers. Movement of the conveyor is controlled by the controller 24. In the exemplary embodiment, the controller 24 indexes the conveyor only after a batch 16 is released onto the belt. One controller that can be used to control the belt 36 is a Gainco GS-3300 controller.

In the exemplary embodiment, the controller is responsible for functions of the system 10 as well as stopping and starting the conveyor 40 that supplies product portions 14 and the conveyor 36 that takes the batches 16 to a packaging station. The controller may include an emergency stop button that powers down the conveyors 36, 40 The controller 24 is preferably located for easy access by the operators 84 and has a touch screen interface. The controller may include a port for downloading data. The conveyor 40 may also include a diverting arm at the entrance or exit 43 of the conveyor to divert flow of product portions 14 if the system 10 becomes inactive. The diverter may be manually operated or the controller 24 may provide an infeed belt on/off signal that activates a diverting arm at the exit 44 of the conveyor 40 to send product to a backup vat or container. The controller may provide a system “ready” or “operational” signal or a “caution” signal. The controller also provides a take away conveyor indexing signal. In addition to the signals from the weighers, the controller is provided with signals from the packaging machine, the infeed conveyor 40, and the ouffeed conveyor 36 that indicate whether or not the bagger and the conveyors are ready.

In the exemplary embodiment, software of controller 24 provides a graphical user interface for the operator 84. The graphical user interface allows the operator to calibrate the load cells 82, set up the desired weight range for each weigh station, make time delay or allowable % away from target weight adjustments, name and save weight range and directing structure sequencing/timing set ups, set up the time delay before indexing the take away conveyor 36 after each dump.

FIG. 11 is a schematic representation of weighers 22A, 22B, 22C, 22D and two operators 84. The first operator is responsible for weighers 22A, 22B and the second operator is responsible for weighers 22C, 22D. The graphical user interface allows the user to set up the weigher filling order. Referring to FIG. 11, the first weigher 22C may be filled, followed by the second weigher 22B, followed by the third weigher 22C, followed by the fourth weigher 22D or the first weigher may be filled, followed by the third weigher, followed by the second weigher, followed by the fourth weigher. Any such sequence could be selected with the graphical user interface.

The graphical user interface allows the user to shut down any weigher 22 and prevent the directing structure from sending product to the inactive weigher 22. The system 10 can operate with any combination of the weighers 22 being inoperative. In the exemplary embodiment the graphical user interface indicates which weigher(s) are inactive.

The controller software may include an inactive station timeout function. This function will stop or divert the infeed conveyor 38 if the ability of the system 10 to process the product becomes compromised. The system can be compromised if the operator lacks product to add to “make weight,” product jams in the diverters, and/or air pressure used to open the doors of the diverters, weighers or staging hoppers is lost.

The graphical user interface also allows the operators 84 to open and close the doors for cleaning when the system is inactive. The interface may display performance data, such as the weight per hour of product entering the system, the number of batch dumps per minute for the system, the cumulative number of dumps per station per shift. The graphical user interface may also include a multiple language set up. The interface may graph product infeed flow per shift, batch dumps per minute over shift and/or total dumps per station per operator per shift.

In the exemplary embodiment, the system is powered by 230 VAC, three phase voltage and 80 psi of air pressure. The materials used to construct the system are per NSF/3-A Standard for Food Processing Equipment (ANSI/NSF/3-A 141159-1) and meet IP-56 level of protection from dust and water.

A station disable switch may be included at each station. A manual dump switch may be included at each station. Multiple, dual or quad systems may work together on a single flighted take away conveyor 36. In this embodiment, each system tracks the empty pockets of the flighted belt. In one embodiment, the controller tracks the line speed of an upstream cutup line. A counter counts the product on the upstream cutup line. The count is used to estimate incoming flow rates. This information is used to stop or divert the infeed conveyor flow should the flow rate exceed the capacity of the system 10, preventing overflow.

Table 1 shows the status of a power-on LED, the infeed belt, the take away belt, an infeed diverter arm, a system ready contact, and a system warning contact for a variety of machine states.

| | External Outputs | | | | | |
|---|---|---|---|---|---|---|
| | | | Index | | System | System |
| | Power on | | Takeaway | Infeed Belt | Ready | Warning |
| Machine States | LED | Infeed Belt | Belt | Diverter arm | Contact | Contact |
| Power off | Off | Turn off | Off | Not divert | Off | Off |
| power on and system ready | On | On | Off | Not divert | On | Off |
| power on and system impaired | On | On | Off | Not divert | Off | On |
| Normal Operation | On | On | Off | Not divert | On | Off |
| Weigh Hopper down or turned off | On | On | Off | Not divert | On | On |
| System not ready, divert infeed | On | On | Off | divert | Off | On |
| System not ready, stop infeed belt | On | Off | Off | Not divert | Off | On |
| Bagger down or Inactive, divert infeed | On | On | Off | divert | Off | On |
| Bagger down or Inactive, stop infeed | On | Off | Off | Not divert | Off | On |
| Emergency stop, divert | On | On | Off | divert | Off | On |
| Emergency stop, stop infeed | On | Off | Off | Not divert | Off | On |
| Weigh hopper ready to dump | On | On | Off | Not divert | On | Off |
| Weigh hopper just dumped | On | On | On | Not divert | On | Off |

The disclosed system 10 sorts product portions into batches. The product portions are directed from a supply along a first flow path. A plurality of the product portions 14 is accumulated from the first flow path and weighed. When the plurality of product portions reaches a predetermined weight, the product portions are directed from the supply along another flow path, accumulated and weighed. When the weight of an accumulated plurality of product portions is within a predetermined weight range, the plurality or batch is discharged. This process is iterated to divide the supply 12 of product portions into batches 16.

In the exemplary embodiment, the disclosed system eliminates most of the manual hand loading of product portions into a weigher by automatically diverting the stream of product portions in an alternating fashion to multiple weighers. This can double the output of each operator, since each operator only has to add or subtract portions or pieces of portions to “make weight” and does not have to load each weigher. In the exemplary embodiment, batches having an unacceptable weight are not produced, since the control system does not allow the passage of the weighed portions to the staging hopper until the desired batch weight has been achieved. The staging hoppers also allow for the immediate discharge of each weigher once the weight of product portions in the weigher is an acceptable weight without concern for any downstream operations. Immediate discharge facilitates fast operation.

Although the present invention has been described with a degree of particularity, it is the intent that the invention include all modifications and alterations falling within the spirit or scope of the appended claims.

1) A method for sorting product portions into batches, comprising:
a) directing product portions from a supply along a first flow path;
b) accumulating a first plurality of said product portions at a first weighing station on said first flow path;
c) weighing said first plurality of product portions;
d) directing said product portions from said supply along a second flow path when a weight of said first plurality of product portions reaches a first predetermined weight;
e) discharging a first batch of said product portions when said weight of said first plurality of product portions is within a first predetermined weight range;
f) accumulating a second plurality of said product portions at a second weighing station on said second flow path;
g) weighing said second plurality of product portions;
h) directing said product portions from said supply along said first flow path after a weight of said second plurality of product portions reaches a second predetermined weight; and,
i) discharging a second batch of said product when said weight of said second plurality of product portions is within a second predetermined weight range.

2) The method of claim 1 wherein said second predetermined weight range is the same weight range as the first predetermined weight range.

3) The method of claim 2 further comprising manually adding product to said first plurality of product portions or manually removing product from said first plurality of product portions to bring said weight of said first plurality of product portions within said first predetermined weight range.

4) The method of claim 1 wherein said product portions are directed along said first flow path when a weight of said second plurality of product portions reaches said second predetermined weight.

5) The method of claim 1 wherein said first predetermined weight is equal to said second predetermined weight.

6) A method for sorting product portions into batches, comprising:
a) directing product portions from a supply along a first flow path;
b) accumulating a first plurality of said product portions at a first weighing station on said first flow path;
c) weighing said first plurality of product portions;
d) directing said product portions from said supply along a second flow path when a weight of said first plurality of product portions reaches a first predetermined weight;
e) discharging a first batch of product portions when a weight of said first plurality of product portions is within a first predetermined weight range;
f) accumulating a second plurality of said product portions at a second weighing station on said second flow path;
g) weighing said second plurality of product portions; and
h) discharging a second batch of product portions when a weight of said second plurality of product portions is within a second predetermined weight range.

7) The method of claim 6 further comprising adding product to said first plurality of product portions and removing product from said first plurality of product portions to bring said weight of said first plurality of product portions within said first predetermined weight range.

8) The method of claim 6 wherein said first predetermined weight range and the second predetermined weight range are the same weight range.

9) The method of claim 6 further comprising directing said product portions along said first flow path when a weight of said second plurality of product portions reaches a second predetermined weight.

10) The method of claim 9 wherein said first predetermined weight is equal to said second predetermined weight.

11) A method for sorting product portions into batches, comprising:
a) directing product portions from a supply along a first flow path;
b) accumulating a first plurality of said product portions at a first weighing station on said first flow path;
c) weighing said first plurality of product portions;
d) directing said product portions along a second flow path when a weight of said first plurality of product portions reaches a first predetermined weight;
e) adjusting said weight of said first plurality of product portions by adding product to said first plurality of product portions or removing product from said first plurality of product portions to bring said weight of said first plurality of product portions within a first predetermined weight range;
f) discharging a first batch of product portions when said weight of said first plurality of product portions is within said first predetermined weight range;
g) accumulating a second plurality of said product portions at a second weighing station on said second flow path;
h) weighing said second plurality of product portions;
i) directing said product portions along said first flow path when a weight of said second plurality of product portions reaches a second predetermined weight;
j) adjusting said weight of said second plurality of product portions by adding product to said second plurality of product portions or removing product from said second plurality of product portions to bring said weight of said second plurality of product portions within a predetermined weight range; and
k) discharging said second plurality of product portions when said weight of said second plurality of product portions is within said second predetermined weight range.

12) The method of claim 11 wherein said first predetermined weight range and the second predetermined weight range are the same weight range.

13) The method of claim 11 wherein a said first predetermined weight is equal to said second predetermined weight.

14) A method for sorting product portions into batches, comprising:
a) directing product portions from a supply along a first flow path;
b) accumulating a first plurality of said product portions at a first weighing station on said first flow path;
c) weighing said first plurality of product portions;
d) directing said product portions along a second flow path when a weight of said first plurality of product portions reaches a first predetermined weight;
e) accumulating a second plurality of said product portions at a second weighing station on said second flow path;
f) weighing said second plurality of product portions;
g) directing said product portions along a third flow path when a weight of said second plurality of product portions reaches a second predetermined weight;
h) accumulating a third plurality of said product portions at a third weighing station on said third flow path;
i) weighing said third plurality of product portions;
j) directing said product portions along a fourth flow path when a weight of said third plurality of product portions reaches a third predetermined weight;
k) accumulating a fourth plurality of said product portions at a fourth weighing station on said fourth flow path;
l) weighing said fourth plurality of product portions; and
m) directing said product portions along said first flow path when a weight of said fourth plurality of product portions reaches a fourth predetermined weight.

15) The method of claim 14 further comprising adding product to said first plurality of product portions or removing product from said first plurality of product portions to bring said weight of said first plurality of product portions within a first predetermined weight range.

16) The method of claim 14 wherein said first, second, third and fourth predetermined weights are equal.

17) A system for sorting a supply of product portions into batches, comprising:
a) a directing structure having an entrance that accepts said supply of product portions from the supply;
b) a first weigher for accepting said product portions from said directing structure, said first weigher accumulating said product portions and producing a first weight signal having a value that relates to a weight of product portions accumulated in said first weigher, said first weigher including an exit;
c) a second weigher for accepting said product portions from said directing structure, said second weigher accumulating said product portions and producing a second weight signal having a value that relates to a weight of product portions accumulated in said second weigher, said second weigher including an exit;
d) a batch weight controller receiving said first and second weight signals from said first and second weighers and sending signals for operating the directing structure, said first weigher, and said second weigher, said controller sends a first signal to operate said directing structure to direct the product portions along a first flow path to the first weigher until said value of said first weight signal indicates that the accumulated weight of product portions in the first weigher has reached a first predetermined weight, when the product portions in the first weigher reaches said first predetermined weight said controller sends a second signal to operate said directing structure to direct the product portions from the supply along a second flow path to the second weigher until said value of said second weight signal indicates that the accumulated weight of product portions in the second weigher has reached a second predetermined weight.

18) The system of claim 17 wherein said controller sends a third signal to open said exit of said first weigher when said weight of product portions in the first weigher is within a first predetermined weight range.

19) The system of claim 17 further comprising a first staging hopper positioned to receive a batch of product portions from the first weigher, said controller provides a signal to the staging hopper that controls a time of release of said batch of product portions from the staging hopper.

20) The system of claim 17 further comprising a funnel that directs batches of said product portions from said first weigher and said second weigher to a predetermined location.

21) The system of claim 14 wherein the first predetermined weight is equal to the second predetermined weight.

22) A system for sorting a supply of product portions into batches, comprising:
a) a directing structure having an entrance that accepts said supply of product portions from the supply;
b) a first weigher for accepting said product portions from said directing structure, said first weigher accumulating said product portions and producing a first weight signal having a value that relates to a weight of product portions accumulated in said first weigher, said first weigher including an exit;
c) a second weigher for accepting said product portions from said directing structure, said second weigher accumulating said product portions and producing a second weight signal having a value that relates to a weight of product portions accumulated in said second weigher, said second weigher including an exit;
d) a batch weight controller receiving said first and second weight signals from said first and second weighers and sending signals for operating the directing structure, said first weigher, and said second weigher, said controller sends a first signal to operate said directing structure to direct the product portions along a first flow path to the first weigher until said value of said first weight signal indicates that the accumulated weight of product portions in the first weigher has reached a first predetermined weight, when the product portions in the first weigher reaches said first predetermined weight said controller sends a second signal to operate said directing structure to direct the product portions from the supply along a second flow path to the second weigher until said value of said second weighting signal indicates that the accumulated weight of product portions in the second weigher has reached a second predetermined weight, said controller sends a third signal to open said exit of said first weigher when said weight of product portions in the first weigher is within a first predetermined weight range, said controller sends a fourth signal to open said exit of said second weigher when said weight of product portions in the second weigher is within a second predetermined weight range.

23) The system of claim 22 wherein said first predetermined weight range is the same weight range as the second predetermined weight range.

24) An apparatus for sorting meat portions from a supply of meat portions into batches, comprising:
a) a diverter having an entrance opening that accepts said supply of meat portions provided by said conveyor and first and second exit openings that include first and second doors;
b) a first weigher for accepting said meat portions from said first exit opening of the diverter when said first door of the diverter is open, said first weigher accumulating said meat portions and producing a first weight signal having a value that relates to a weight of meat portions accumulated in said first weigher, said first weigher including an exit including an exit opening having a door;
c) a second weigher for accepting said meat portions from said second exit opening of the diverter when said second door of the diverter is open, said second weigher accumulating said meat portions and producing a second weight signal having a value that relates to a weight of meat portions accumulated in said second weigher, said second weigher including an exit including an exit opening having a door; and
d) a batch weight controller that receives said first and second weight signals from said first and second weighers and sends signals for operating the diverter, said first weigher, and said second weigher, said controller causes said first door of the diverter to open to provide meat portions to said first weigher until said value of said first weight signal indicates that the weight of meat portions in the first weigher has reached a first predetermined weight, said controller causes said first door of the diverter to close and said second door of the diverter to open to provide meat portions to said second weigher when said weight of meat portions in the first weigher reaches said first predetermined weight until said value of said second weight signal indicates that the weight of meat portions in the second weigher has reached a second predetermined weight, said controller causes said door of said first weigher to open when said weight of meat portions in the first weigher is within a first predetermined weight range, said controller causes said door of said second weigher to open when said weight of meat portions in the second weigher is within a second predetermined weight range.

25) The apparatus of claim 24 further comprising a first staging hopper positioned to receive a batch of meat portions from the first weigher, said controller provides a signal the staging hopper that controls a time of release of said batch of meat portions from the staging hopper.

26) The apparatus of claim 24 further comprising a funnel that directs batches of said meat portions from said first weigher and said second weigher to a predetermined location.

27) The apparatus of claim 24 wherein the first predetermined weight is equal to the second predetermined weight.

28) The apparatus of claim 24 wherein the first predetermined weight range is the same as the second predetermined weight range.

29) The apparatus of claim 24 wherein said directing chute includes a directing flap movable between a first position that directs product portions from said entrance opening to said first exit opening and a second position that directs product portions from said entrance opening to said second exit opening.

30) The apparatus of claim 29 wherein said batch weight controller moves said directing flap to said first position when said controller causes said first door of the directing chute to open.

31) An apparatus for sorting a supply of product portions into batches, comprising:
a) a first diverter having an entrance that accepts said supply of product portions from the supply and first and second exits;
b) a second diverter having an entrance that accepts product portions from the first exit of the first diverter and first and second exits;
c) a third diverter having an entrance that accepts product portions from the second exit of the first diverter and first and second exits;
d) a first weigher that accepts said product portions from said first exit of the second diverter, said first weigher including an exit having a door;
e) a second weigher that accepts said product portions from said second exit of the second diverter, said weigher including an exit having a door;
f) a third weigher that accepts said product portions from said first exit of the third diverter, said first weigher including an exit having a door;
g) a fourth weigher that accepts said product portions from said second exit of the third diverter, said weigher including an exit having a door;
h) a batch weight controller that receives weight information from said weighers, and batch weight controller sends signals for operating the diverters and the weighers, said controller sends a first signal to operate the diverters to direct the product portions from the supply to the first weigher until a weight of product portions in the first weigher reaches a first predetermined weight, when the product portions in the first weigher reach said first predetermined weight said controller sends a signal to operate said diverters to direct the product portions from the supply to the second weigher until a weight of product portions in the second weigher reaches a second predetermined weight, when the product portions in the second weigher reach said second predetermined weight said controller sends a signal to operate said diverters to direct the product portions from the supply to the third weigher until a weight of product portions in the second weigher reaches a third predetermined weight, when the product portions in the third weigher reach said third predetermined weight said controller sends a signal to operate said diverters to direct the product portions from the supply to the fourth weigher until a weight of product portions in the fourth weigher reaches a fourth predetermined weight, when the product portions in the fourth weigher reach said fourth predetermined weight said controller sends a second signal to operate said diverters to direct the product portions from the supply to the first weigher.

32) The apparatus of claim 31 wherein each of said directing chutes include a directing flap movable between a first position that directs product portions from the entrance opening of the directing chute to the first exit opening of the directing chute and a second position that directs product portions from the entrance opening of the directing chute to the second exit opening of the directing chute.
